(19) United States
(12) Patent Application Publication
(10) Pub. No.: US 2026/0350177 A1
(43) Pub. Date: Nov. 5, 2026

(54) MITIGATING RISKS ASSOCIATED WITH APPLICATION PROGRAMMING INTERFACES IN SOURCE CODE

(71) Applicant: International Business Machines Corporation, Armonk, NY (US)

(72) Inventors: Bharath Nandroli Vishwanatha ITHAL, Bangalore (IN); Rashmi KHANNA, Bangalore (IN); Yang Shyr MEI, Bengaluru (IN); Elaprolu RANI PRATHYUSHA, Palnadu (IN)

(21) Appl. No.: 19/197,639

(22) Filed: May 2, 2025

(51) Int. Cl. G06F 21/57; G06F 21/54

(52) U.S. Cl. CPC G06F 21/577; G06F 21/54

(57) ABSTRACT

In some implementations, a server may obtain application programming interface (API) metadata associated with a third-party API. The server may analyze application source code to obtain API usage information associated with the application source code. The server may calculate a risk score for the application source code, wherein the risk score is based on the API metadata and the API usage information. The server may generate, based on the risk score, a recommendation to mitigate a risk associated with the third-party API.

### BACKGROUND

This disclosure relates to computer systems, and more specifically, to mitigating risks associated with application programming interfaces (APIs) in source code.

### SUMMARY

Some aspects described herein relate to a method. The method may include obtaining, by a server, API metadata associated with a third-party API. The method may include analyzing, by the server, application source code to obtain API usage information associated with the application source code. The method may include calculating, by the server, a risk score for the application source code, where the risk score is based on the API metadata and the API usage information. The method may include generating, by the server and based on the risk score, a recommendation to mitigate a risk associated with the third-party API.

Some aspects described herein relate to a computer system. The computer system may include a processor set, one or more computer-readable storage media, and program instructions stored on the one or more computer-readable storage media to cause the processor set to perform operations. The operations may include obtaining API metadata associated with a third-party API. The operations may include analyzing application source code to obtain API usage information associated with the application source code. The operations may include determining a risk score for the application source code, where the risk score is based on the API metadata and the API usage information. The operations may include generating, based on the risk score, a code snippet with modified application source code to mitigate a risk associated with the third-party API.

Some aspects described herein relate to a computer program product. The computer program product may include one or more computer-readable storage media and program instructions stored on the one or more computer-readable storage media to perform operations. The operations may include obtaining API metadata associated with a third-party API. The operations may include analyzing application source code to obtain API usage information associated with the application source code. The operations may include determining a risk score for the application source code, where the risk score is based on the API metadata and the API usage information. The operations may include generating, based on the risk score, a code snippet with modified application source code. The operations may include inserting the code snippet into the application source code.

### BRIEF DESCRIPTION OF THE DRAWINGS

FIG. 1 is a diagram of an example computing environment for mitigating risks associated with third-party APIs in application source code.

FIG. 2 is a diagram illustrating an example associated with mitigating risks associated with third-party APIs in application source code.

FIG. 3 is a diagram illustrating an example associated with mitigating risks associated with third-party APIs in application source code.

FIG. 4 is a diagram illustrating an example associated with determining a risk score.

FIG. 5 is a diagram illustrating an example associated with a software development flow.

FIG. 6 is a flowchart of an example process associated with mitigating risks associated with APIs in source code.

### DETAILED DESCRIPTION

The following detailed description of example implementations refers to the accompanying drawings. The same reference numbers in different drawings may identify the same or similar elements.

Developers may utilize third-party application programming interfaces (APIs) in their applications to harness various functionalities and services. However, when these third-party APIs undergo updates or version changes, they may introduce breaking changes, optimizations, or hidden risks that can significantly impact the stability and security of the applications that rely on the third-party APIs. Such updates may alter the API's syntax, introduce new parameters, modify existing parameters, or change a response structure.

One challenge in this scenario is identifying potential risks and impacts associated with these updates, especially when the changes are not immediately apparent. Moreover, assessing the effects of these changes on the application's code may be a tedious and resource-intensive task. The manual process of reviewing API documentation, analyzing code, and testing for compatibility issues may lead to delays and increased development costs, which may waste compute and network resources, thereby degrading an overall system performance.

In some implementations, a system may provide automated risk management for third-party APIs that integrate into a software development pipeline. The system may gather API metadata. The API metadata may indicate API documentation and a syntax associated with using the third-party APIs. The system may analyze application source code to detect breaking changes, new parameters, and usage frequency of the third-party APIs. The system may compute a risk score based on the detected factors. The system may generate actionable insights to help fix potential issues. For example, the system may leverage an AI-powered code assistant to generate code snippets that address compatibility issues and enhance an overall security and efficiency of the application. In some aspects, the risk score computation may take into account attributes such as breaking changes, new parameters, usage frequency, dependency risks, and business criticality, with weights assigned to each attribute based on organizational requirements.

In some implementations, the system may determine the risk score based on breaking changes, new parameters, a usage frequency, dependency risks, and criticality. Breaking changes may be associated with A1 and W1, new parameters may be associated with A2 and W2, usage frequency may be associated with A3 and W3, dependency risks may be associated with A4 and W4, and criticality may be associated with A5 and W5. In this example, “W” is a weight assigned for an attribute and “A” is the risk score assigned for an API for a particular attribute. The weights may be set depending on an importance level to an organization or a developer. When a relatively large weight is set for an attribute and that attribute results in a relatively high risk score, the AI-powered code assistant may generate the code snippets to resolve the issue.

In some implementations, the system may integrate risk management into the software development pipeline to detect and mitigate risks associated with third-party API usage. The system may analyze the application source code for API usage patterns. The system may gather API metadata associated with the third-party APIs. The system may detect breaking changes, new parameters, and usage frequency of the third-party APIs. The system may compute a risk score based on the detected changes and API usage patterns. The system may generate actionable insights to help fix potential issues. For example, the system may generate code snippets that address compatibility issues associated with the breaking changes.

In some implementations, the system may incorporate risk management into the software development pipeline as a hook that runs before merging a pull request into a main branch of the application source code. The system may identify the API usage frequency and a business impact of potential changes. The system may use an algorithm to detect differences in syntax and logic between different API versions. The server may determine a score for breaking changes, new parameters, usage frequency, software development kit (SDK) dependency risks, and business criticality. The system may use an AI-powered code assistant to generate code snippets that address compatibility issues. The system may analyze the application source code for API usage patterns to detect potential security vulnerabilities. The system may receive notifications of updates to the third-party APIs. The system may rank risks associated with the third-party APIs based on the computed risk scores. The system may provide recommendations to developers to fix potential issues based on the actionable insights.

In some implementations, the system may compute the risk scores based on weights assigned to each of the breaking changes, new parameters, usage frequencies, and dependency risks associated with the third-party APIs. The system may adjust the weights based on organizational requirements. The system may generate the code snippets using an AI-powered code assistant that provides suggestions for modifying the application source code to accommodate changes made by a provider of the third-party APIs. The system may be integrated with a continuous integration/continuous deployment (CI/CD) pipeline. The system may detect affected APIs, generate code snippets to fix issues associated with the affected APIs, and report the risk score and the generated code snippets. The system may stop a merge of the application source code into the main branch when the risk score exceeds a predetermined threshold, until the generated code snippets are applied to the application source code to mitigate the risk associated with the affected APIs.

In some implementations, the system may optimize the detection and mitigation of potential security vulnerabilities and errors associated with third-party API updates, thereby conserving processing resources, memory resources, and network resources that would have otherwise been consumed by attempting to manually detect and mitigate these risks. The system may reduce the likelihood of security breaches, downtime, and data loss by identifying and addressing potential issues before they impact the application's stability and security. The system may streamline development workflows by integrating with the software development pipeline, automating tasks such as risk detection, code review, and testing, thereby conserving resources associated with manual development workflows. Additionally, the system may minimize computational overhead associated with error-prone code and security vulnerabilities by generating optimized code snippets. In this way, the risk management system may conserve computing resources, networking resources, and/or the like.

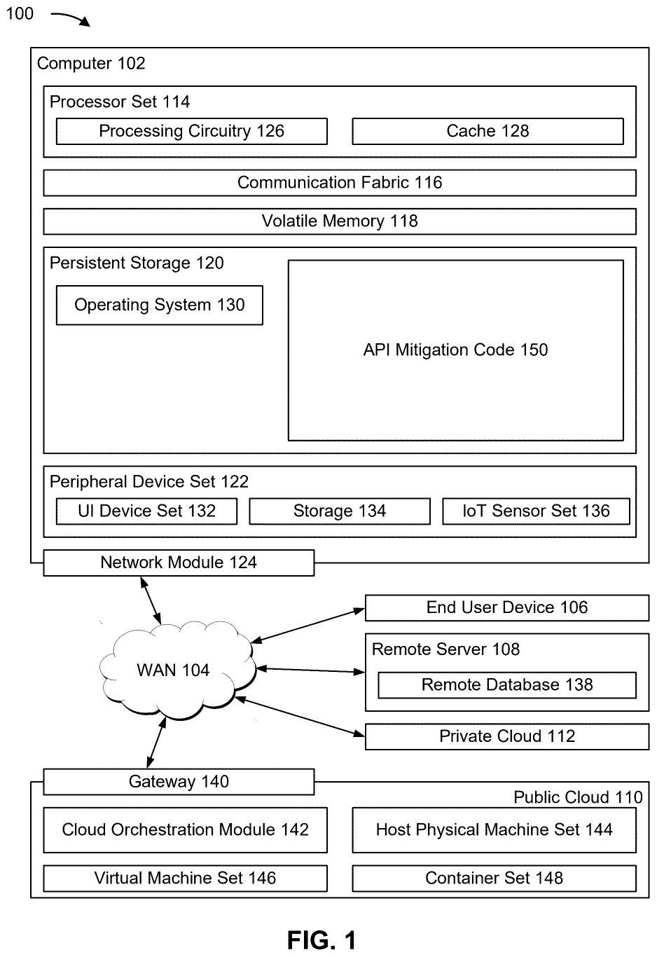

FIG. 1 is a diagram of an example computing environment 100 for mitigating risks associated with third-party APIs in application source code.

The computing environment 100 contains an example of an environment for the execution of at least some of the computer code involved in performing the inventive methods, such as API mitigation code 150. In addition to the API mitigation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the API mitigation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in API mitigation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the API mitigation code 150 typically includes at least some of the computer code involved in performing one or more operations described herein. The operations may include, for example, obtaining API metadata associated with a third-party API; analyzing application source code to obtain API usage information associated with the application source code; determining a risk score for the application source code, wherein the risk score is based on the API metadata and the API usage information; generating, based on the risk score, a code snippet with modified application source code; and inserting the code snippet into the application source code.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

A third-party API is an API provided by an external service or company (a “third party”) that allows developers to access features or data from third party platforms. A third-party API is a set of functions and protocols provided by another company or service that can be used in the developer's application. A third-party API may be interacted with by making hypertext transfer protocol (HTTP) requests to its endpoints. The third-party API may send back data. For example, data may be sent back in a JavaScript object notation (JSON) format. Such data may be parsed and used accordingly by the application.

Developers may be able to integrate existing tools and services through these APIs. Third-party APIs may be utilized for payment, maps/location, social media, weather, messaging/communication, or authentication. Third-party APIs may be used to save time and resources, bring additional functionality to the developer's applications, and offer access to real-time updated data. As an example, when building an application that uses weather data, instead of building a separate weather-tracking service, the developer may use a third-party weather API.

When using third-party APIs from open-source or inner-source projects, updates to third-party APIs may introduce breaking changes, optimizations, or hidden risks. For example, a previously optional parameter may become a required parameter, which may result in an error. Code associated with the application may depend on the third-party API, and in some cases, a latest version of the third-party API may introduce a new parameter and modify a response structure. A new parameter may be able to simplify a logic but may be missed by the developer. A software development kit may be pulling in vulnerable dependencies. In these examples, such scenarios may impact stability and security of the application, thereby degrading an overall system performance.

In some implementations, a software tool may provide automated risk management for third-party APIs. When a consumer uses the software tool to analyze risks, the software tool may generate a report assigning risk scores to a plurality of third-party APIs associated with an application. The software tool may assign the risk scores based on detected changes associated with the third-party APIs. The risk scores may be accompanied by an explanation. The software tool may include a code assistant that is able to generate code snippets that potentially fix code problems due to the detected changes. The code problems may be found in software code associated with the application. The software tool may generate the code snippets based on the risk scores. The code snippets may be inserted into the software code in order to resolve the code problems. For example, a developer may accommodate required changes based on the insertion of the code snippets into the software code. Such a process may be performed statically and run as a pre-hook before merging a pull request into a main branch of the software code, which may prevent potential issues caused by changes in third-party APIs.

In some implementations, the software tool may gather API metadata associated with the software code. The software tool may analyze application source code for API usage patterns. The software tool may check to detect breaking changes associated with the third party APIs. The software tool may determine a risk score. The software tool may employ an algorithm to compute the risk score for third-party API usage, which may provide insights into whether the third-party APIs are utilized optimally and securely. The software tool may integrate risk assessment for third-party libraries into code reviews to identify and mitigate potential vulnerabilities in applications. The software tool may generate actionable insights based on the risk score. For example, the software tool may leverage an AI-powered code assistant to automatically generate code snippets that address compatibility issues arising from changes in third-party APIs. The AI-powered code assistant may use generative artificial intelligence (AI) to generate the code snippets, where the generative AI may be enhanced over time.

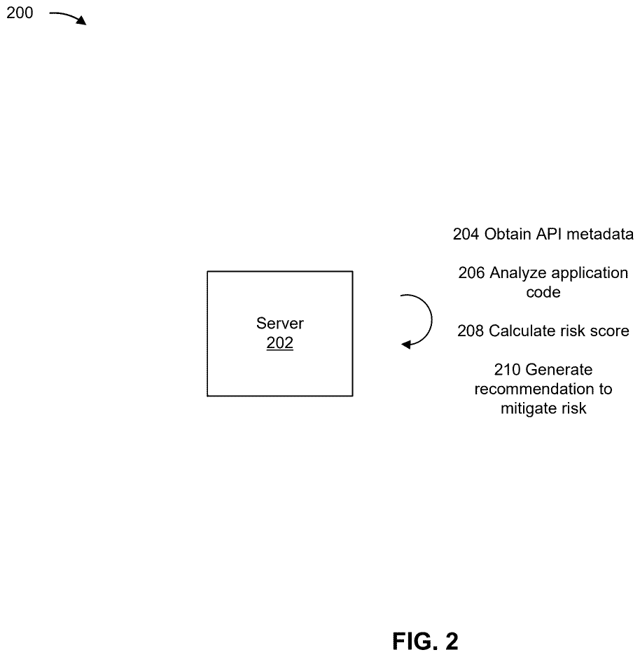

FIG. 2 is a diagram illustrating an example 200 associated with mitigating risks associated with third-party APIs in application source code. The example 200 may include a server 202 that performs various functions.

As shown by reference number 204, the server 202 may obtain API metadata associated with a third-party API. The server 202, when obtaining the API metadata, may retrieve an API schema and change logs associated with the third-party API. The server 202 may initiate the process by obtaining the API metadata associated with the third-party API. The API metadata may be used for understanding the structure, behavior, and usage of the third-party API. The server 202 may retrieve the API schema and the change logs associated with the third-party API in order to understand the third-party API. The API schema may provide a blueprint of the API's structure, including the parameters, data types, and response formats. The change logs may contain records of changes made to the third-party API over time, including updates, bug fixes, and new features.

As shown by reference number 206, the server 202 may analyze application source code to obtain API usage information associated with the application source code. The server 202, when analyzing the application source code, may identify the API usage information associated with the application source code. The API usage information may include one or more API calls, one or more parameters, or a response structure. The server 202 may identify the API usage information, which may include one or more API calls, one or more parameters, or the response structure. The server 202 may examine the application source code to determine how the third-party API is being used, including the frequency of API calls, the parameters passed to the third-party API, and the expected response structure.

As shown by reference number 208, the server 202 may calculate a risk score for the application source code. The risk score may be based on the API metadata and the API usage information. The server 202 may calculate the risk score based on one or more attributes of the application source code and respective weights associated with the one or more attributes. The one or more attributes may include breaking changes in the application source code, a number of new or changed parameters in the application source code, an API usage frequency in the application source code, a dependency risk associated with the third-party API, or a criticality of the third-party API in the application source code. The one or more attributes may include a changed response structure. The changed response structure may be detected based on the API metadata and an analysis of the application source code.

In some implementations, the server 202 may calculate the risk score to the application source code. The risk score may be based on the API metadata and the API usage information and may take into account various attributes of the application source code and their respective weights. The attributes may include breaking changes in the application source code, which may indicate potential compatibility issues with the third-party API. The attributes may include a number of new or changed parameters in the application source code, which may affect the stability and security of the application. The attributes may include an API usage frequency in the application source code, which may impact the performance and reliability of the application. The attributes may include a dependency risk associated with the third-party API, which may affect the overall security and stability of the application. The attributes may include a criticality of the third-party API in the application source code, which may indicate the potential impact of API changes on the application's functionality and user experience. The attributes may include a changed response structure, which may be detected based on the API metadata and the analysis of the application source code.

As shown by reference number 210, the server 202 may generate, based on the risk score, a recommendation to mitigate a risk associated with the third-party API. The server 202 may determine that the risk score satisfies a defined threshold. The server 202 may generate the recommendation based on the risk score satisfying the defined threshold. The server 202 may calculate the risk score and generate the recommendation as part of a software development flow. The server 202, when generating the recommendation, may generate a code snippet with modified application source code. The code snippet may accommodate changes made by an API provider. The server 202 may insert the code snippet into the application source code. The server 202 may output a report that indicates the risk score prior to merging a pull request to the third-party API into a main branch of the application source code.

In some implementations when the risk score satisfies the defined threshold, the server 202 may generate the recommendation to mitigate the risk associated with the third-party API. This recommendation may include the code snippet with modified application source code that accommodates changes made by the API provider. The server 202 may insert the code snippet into the application source code to ensure seamless integration with the third-party API. Additionally, the server 202 may output the report that indicates the risk score prior to merging the pull request to the third-party API into the main branch of the application source code. The report may provide valuable insights into the potential risks associated with the third-party API and enable developers to make informed decisions about their application's security and stability.

FIG. 2 is provided as an example. Other examples may differ from what is described with regard to FIG. 2.

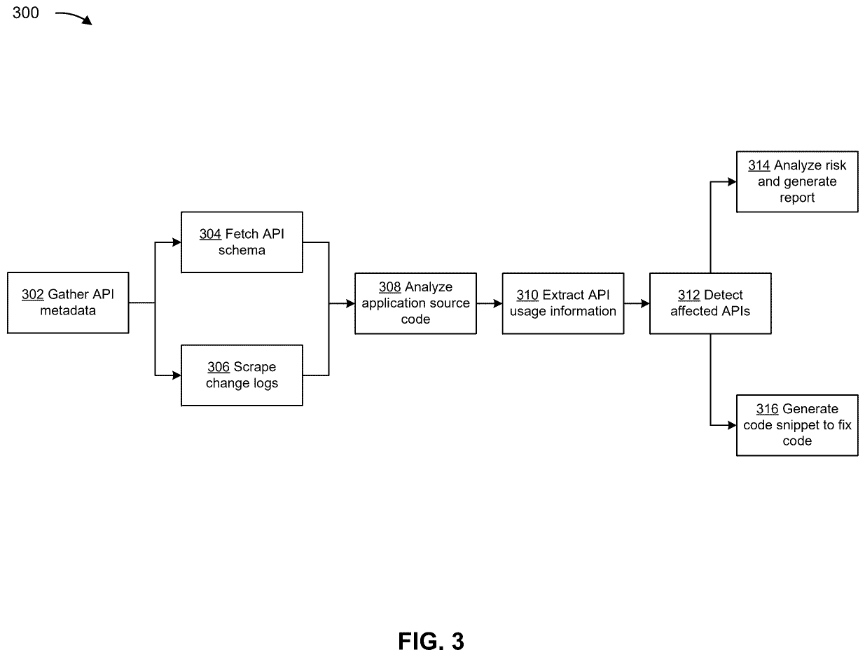

FIG. 3 is a diagram illustrating an example 300 associated with mitigating risks associated with third-party APIs in application source code.

As shown by reference number 302, a software tool, which may be implemented using a server, may gather API metadata. The API metadata may contain information regarding a third-party API. The API metadata may define a structure, a behavior, and a usage of the third-party API. The API metadata may include information regarding an API name, an API version, a description of the third-party API, a root endpoint for API calls, and information regarding an API maintainer. The software tool may be associated with a software development system. The software tool may be designed to gather API metadata. The API metadata may contain detailed information regarding a specific third-party API, such as its name, version, and a comprehensive description of its functionality and intended use. This information may be crucial in defining the structure, behavior, and usage of the third-party API, enabling the software tool to effectively analyze and interact with the API.

As shown by reference number 304, the software tool may fetch an API schema associated with the third-party API. The API schema may define a structure of API requests and API responses. The API schema may be a blueprint that defines the structure of API requests and responses, including the parameters, data types, and response formats. By analyzing the API schema, the software tool may gain a deeper understanding of how the API functions and identify potential issues.

As shown by reference number 306, the software tool may scrape change logs associated with the third-party API. Change logs may be used to track changes that occur to the third-party API over a period of time. The change logs may include information regarding a time of a change and information regarding the change itself. Change logs may be records of changes made to the third-party API over a period, including the date and time of each change, as well as a description of what was changed. By analyzing the change logs, the software tool may identify potential issues and updates made to the third-party API that may impact application source code that utilizes the third-party API.

As shown by reference number 308, the software tool may analyze the application source code. The application source code may use the third-party API in accordance with the API schema. The application source code may be written in a programming language and may utilize the third-party API in accordance with the API schema. The application source code may be created by a developer to perform a specific task or set of tasks using the third-party API.

As shown by reference number 310, the software tool may extract API usage information from the application source code. The software tool may identify API requests in the application source code. The software tool may identify the API requests made in the application source code, as well as the parameters and data types used in those API requests. The software tool may also identify the version of the third-party API used in the application source code.

As shown by reference number 312, the software tool may detect an affected third-party API. The software tool may detect that the third-party API utilized in the application source code was also identified by the change logs. In other words, the software tool may detect that changes were made to the third-party API that was utilized in the application source code. Such changes made to the third-part API may potentially lead to an error in the application source code. The software tool may detect the affected third-party API by comparing changes made to the third-party API, as recorded in the change logs, against the API usage information extracted from the application source code. When the software tool detects that changes were made to the third-party API that was utilized in the application source code, the software tool may indicate a potential error or issue in the application source code.

As shown by reference number 314, the software tool may analyze a risk associated with the third-party API and generate a report indicating the risk. The software tool may analyze the risk associated with the third-party API and generate a report indicating the risk. This report may provide a risk score or level of risk, as well as recommendations for remedying the issue.

In some implementations, the software tool may determine the risk score. The software tool may use various attributes when assigning the risk score. The software tool may use a presence of absence of breaking changes, which may be represented by a Boolean value (e.g., yes or no) (W1). The software tool may use new parameters, which may be represented by an integer value of a number of new/changed parameters (W2). The software tool may use a usage frequency, which may be represented as a percentage (high, medium, or low mapped to numeric values) (W3). The software tool may use SDK dependency risks, which may be represented by an integer (number of vulnerabilities or transitive dependencies) (W4). The software tool may use a criticality, which may be represented by a percentage (business importance of the third-party API) (W5). The software tool may initialize parameters. The software tool may define weights for each risk factor, ensuring that the weights sum to 1. For example, W1+W2+W3+W4+W5=1. The software tool may assign a score out of 10 for each attribute A, such that a normalized value is equal to a value divided by a maximum value times 10 (e.g., (value/normalized value)×10). In this example, the risk score may be equal to (A1×W1)+(A2×W2)+(A3×W3)+(A4×W4)+(A5×W5).

In some implementations, when assessing the risk associated with the third-party API, the software tool may consider multiple factors that can impact the security and reliability of the application. To assign a comprehensive risk score, several key attributes must be evaluated. These attributes include the presence of breaking changes, the introduction of new parameters, the frequency of API usage, the risks associated with SDK dependencies, and the business criticality of the API. Each of these attributes may play a role in determining the overall risk score, and their relative importance may be weighted accordingly. Breaking changes may impact the stability of an application, and such an attribute may be assigned a weight (W1) and evaluated as a Boolean value (Yes/No). The introduction of new parameters may increase the risk of errors or security vulnerabilities, and such an attribute may be assigned a weight (W2) and evaluated as an integer value representing the number of new or changed parameters. The frequency of API usage may be assigned a weight (W3) and evaluated as a percentage value, with high usage frequencies corresponding to higher risk scores. SDK dependency risks may be another factor, as vulnerabilities in dependent libraries or transitive dependencies may compromise the security of the application. Such an attribute may be assigned a weight (W4) and evaluated as an integer value representing the number of vulnerabilities or transitive dependencies. The business criticality of the third-party API may be assigned a weight (W5) and evaluated as a percentage value, which may reflect the importance of the third-party API to the organization's operations. To compute the risk score, the weights for each risk factor are initialized, ensuring that the weights sum to 1 (e.g., W1+W2+W3+W4+W5=1). Each attribute may be assigned a normalized score out of 10, which may be calculated by dividing the attribute value by the maximum possible value and multiplying by 10. The risk score may be computed by multiplying each attribute score by its corresponding weight and summing the results. By taking into account these multiple attributes and their relative importance, organizations may gain a more nuanced understanding of the risks associated with third-party APIs and make data-driven decisions to ensure the security and reliability of their applications. This approach can help mitigate the risks associated with API usage, which may reduce the likelihood of security breaches or errors.

As shown by reference number 316, the software tool may use a code assistant to generate a code snippet to fix application source code associated with the affected third-party API. The code assistant may analyze the issue and provide a solution in the form of the code snippet, which may be inserted into the application source code to resolve the issue.

In some implementations, different AI models may be used to summarize existing issues and bugs in git repositories source code. Certain tools may fetch information from remote repositories. After data is obtained from the remote repositories, static analysis tools, security vulnerability scanners, or bug-tracking systems may be used to identify and extract security vulnerabilities and bugs. Raw data (e.g., a list of reported vulnerabilities and bug descriptions) may be provided to a language model, which may summarize the raw data, explain issues related to the raw data, and provide insights regarding a mitigation of the vulnerabilities.

In one example, a third-party API may be a weather API. An API update to the third-party API may involve changing from version 1.0 to version 2.0. Version 2.0 of the third-party API may have several changes in relation to version 1.0 of the third-party API. A first change may be related to an endpoint (e.g., a change from/weather to/forecast). A second change may be related to a parameter (e.g., a change from city to location). A third change may be associated with a new required parameter (e.g., units). A fourth change may be associated with a changed response structure. For example, an old response structure may be in accordance with {“temperature”:25, “humidity”:60, “wind_speed”:10}, whereas a new response structure may be in accordance with {“current”: {“temperature”: 25, “humidity”:60, “wind_speed”:10}. In this example, such changes due to the API update may result in code breaks (or breaking changes). In order to resolve the code breaks, a software tool may generate a risk score. The software tool may detect breaking changes, which may be assigned a first weight (e.g., 10). The software tool may detect one new parameter, which may be assigned a second weight (e.g., 5). The software tool may detect a high usage frequency, which may be assigned a third weight (e.g., 10). The software tool may detect a high criticality, which may be assigned a fourth weight (e.g., 10). Based on such scores and assigned weights, the software tool may generate a risk score of X. The software tool may employ a code assistant to generate code snippets that modifies application source code to accommodate changes made by an API provider, which may mitigate the breaking changes caused by the API update.

In another example, an application platform may update open authentication tokens from unencrypted to encrypted as part of an API update. Old tokens may be plain text (unencrypted), and new tokens may be encrypted. Applications replying on unencrypted tokens may break. The API update involving updating the open authentication tokens from unencrypted to encrypted may cause breaking changes. In this example, such changes due to the API update may result in code breaks (or breaking changes). In order to resolve the code breaks, a software tool may generate a risk score. The software tool may detect breaking changes, which may be assigned a first weight (e.g., 10). The software tool may detect a high usage frequency, which may be assigned a third weight (e.g., 10). The software tool may detect a high criticality, which may be assigned a fourth weight (e.g., 10). Based on such scores and assigned weights, the software tool may generate a risk score of X. The software tool may employ a code assistant to generate code snippets that modifies application source code to accommodate changes made by an API provider, which may mitigate the breaking changes caused by the API update.

In this example, existing code may be in accordance with: def validate_token (token):
token =subprocess.run([“oc”, “get”, “useroauthaccesstokens”], capture_output=True, text=True)
return token
The code assistant may suggest fixing the code in accordance with:
   def validate_token (token):
   token =subprocess.run([“oc”, “get”, “useroauthaccesstokens”], capture_output=True, text=True)
   decoded_token=jwt.decode(token, key=“secret”, algorithms=[“HS56”])
   return decoded_token
In this example, the suggested code may replace the existing code, which may resolve the code breaks due to the API update.

In some implementations, an AI model may be used to generate actionable insights. The AI model may be used to detect differences in syntax and logic and then generate suggestions for migrating or refactoring code. The actionable insights may be generated using an AI-powered code assistant. A first prompt to the AI model may include an older version of code that exposes the third-party API. A second prompt to the AI model may include a new version of code that exposes the third-party API. The new version of code may include a newer version of syntax code. A third prompt to the AI model may be code making a request to the older version of the code. The AI model may generate updated code that works with the new version of the code. The updated code may change an endpoint, add middleware to parse a request body as JSON, change query parameters, and update a response structure to include certain fields. With such changes, the updated code may work with the newer version of the code. As a result, the AI model may generate modified code snippets based on different code inputs.

FIG. 3 is provided as an example. Other examples may differ from what is described with regard to FIG. 3.

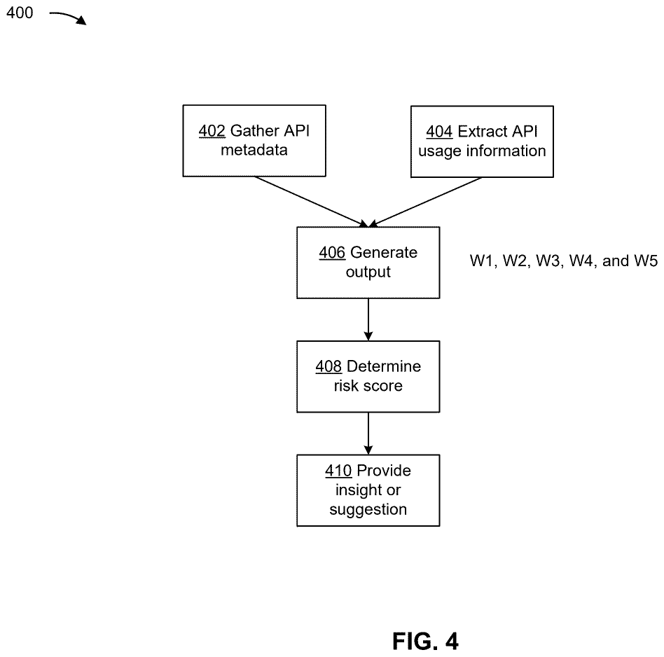

FIG. 4 is a diagram illustrating an example 400 associated with determining a risk score.

As shown by reference number 402, a software tool may gather API metadata. As shown by reference number 404, the software tool may extract API usage information. As shown by reference number 406, the software tool may generate an output. The output may include breaking changes, new parameters, a usage frequency, dependency risks, or a criticality. The breaking changes may be assigned with a first weight (W1). The new parameters may be assigned with a second weight (W2). The usage frequency may be assigned with a third weight (W3). The dependency risks may be assigned with a fourth weight (W4). The criticality may be assigned with a fifth weight (W5). The weights may be pre-assigned for different outputs. As shown by reference number 408, the software tool may determine a risk score, which may be based on W1, W2, W3, W4, and W5. As shown by reference number 410, the software tool may provide an insight or a suggestion based on the risk score.

FIG. 4 is provided as an example. Other examples may differ from what is described with regard to FIG. 4.

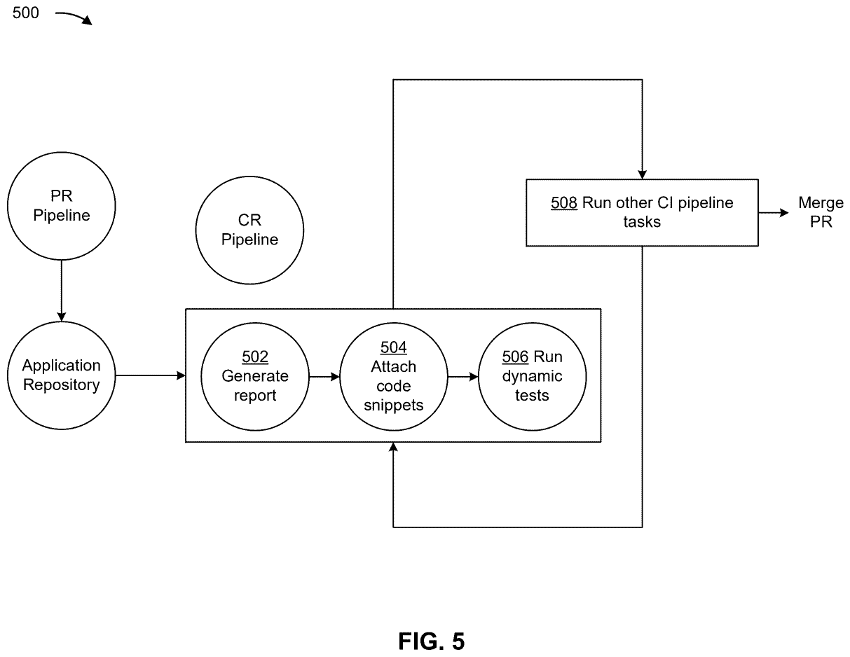

FIG. 5 is a diagram illustrating an example 500 associated with a software development flow.

As shown in FIG. 5, breaking changes may be detected in third-party APIs as part of a software development pipeline. A pull request (PR) pipeline may run a set of compliance status checks on a pull request for a specified application repository. A continuous integration (CI) pipeline may include generating a report with risk analysis (as shown by reference number 502), attaching code snippets in a PR to fix code (as shown by reference number 504), and running dynamic tests (as shown by reference number 506). The CI pipeline may include performing other CI pipeline tasks (as shown by reference number 508). After the other CI pipeline tasks are completed, the PR may be merged with a main branch of application source code. By attaching the code snippets in the PR to fix code prior to the PR being merged with the main branch, breaking changes due to third-party APIs may be resolved.

FIG. 5 is provided as an example. Other examples may differ from what is described with regard to FIG. 5.

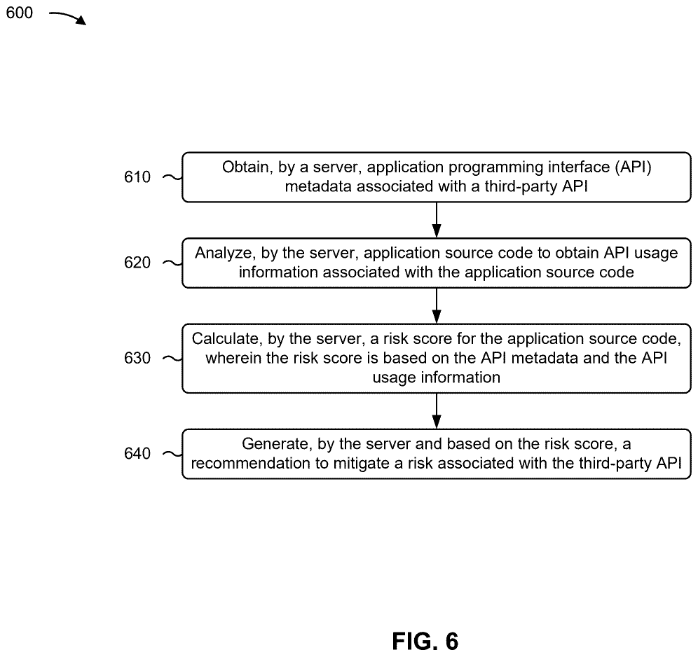

FIG. 6 is a flowchart of an example process 600 associated with mitigating risks associated with APIs in source code. One or more process blocks of FIG. 6 are performed by a server (e.g., server 202) and/or by another device or a group of devices separate from or including the serve.

As shown in FIG. 6, process 600 includes obtaining, by a server, API metadata associated with a third-party API (block 610). For example, the server may obtain, by a server, API metadata associated with a third-party API, as described above.

As further shown in FIG. 6, process 600 includes analyzing application source code to obtain API usage information associated with the application source code (block 620). For example, the server may analyze application source code to obtain API usage information associated with the application source code, as described above.

As further shown in FIG. 6, process 600 includes calculating a risk score for the application source code, wherein the risk score is based on the API metadata and the API usage information (block 630). For example, the server may calculate a risk score for the application source code, wherein the risk score is based on the API metadata and the API usage information, as described above.

As further shown in FIG. 6, process 600 includes generating, based on the risk score, a recommendation to mitigate a risk associated with the third-party API (block 640). For example, the server may generate, based on the risk score, a recommendation to mitigate a risk associated with the third-party API, as described above.

Process 600 may include additional aspects, such as any single aspect or any combination of aspects described below and/or in connection with one or more other processes described elsewhere herein.

In a first aspect, process 600 includes retrieving an API schema and change logs associated with the third-party API.

In a second aspect, alone or in combination with the first aspect, process 600 includes identifying the API usage information associated with the application source code, wherein the API usage information includes one or more API calls, one or more parameters, or a response structure.

In a third aspect, alone or in combination with one or more of the first and second aspects, process 600 includes calculating the risk score based on one or more attributes of the application source code and respective weights associated with the one or more attributes.

In a fourth aspect, alone or in combination with one or more of the first through third aspects, the one or more attributes include breaking changes in the application source code, a number of new or changed parameters in the application source code, an API usage frequency in the application source code, a dependency risk associated with the third-party API, or a criticality of the third-party API in the application source code.

In a fifth aspect, alone or in combination with one or more of the first through fourth aspects, the one or more attributes include a changed response structure, and the changed response structure is detected based on the API metadata and an analysis of the application source code.

In a sixth aspect, alone or in combination with one or more of the first through fifth aspects, process 600 includes determining that the risk score satisfies a defined threshold, wherein the recommendation is generated based on the risk score satisfying the defined threshold.

In a seventh aspect, alone or in combination with one or more of the first through sixth aspects, process 600 includes generating a code snippet with modified application source code, wherein the code snippet accommodates changes made by an API provider, and inserting the code snippet into the application source code.

In an eighth aspect, alone or in combination with one or more of the first through seventh aspects, the risk score is calculated and the recommendation is generated as part of a software development flow.

In a ninth aspect, alone or in combination with one or more of the first through eighth aspects, process 600 includes outputting a report that indicates the risk score prior to merging a pull request to the third-party API into a main branch of the application source code.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

In some implementations, a method comprises: obtaining, by a server, API metadata associated with a third-party API; analyzing, by the server, application source code to obtain API usage information associated with the application source code; calculating, by the server, a risk score for the application source code, wherein the risk score is based on the API metadata and the API usage information; and generating, by the server and based on the risk score, a recommendation to mitigate a risk associated with the third-party API.

In some implementations, obtaining the API metadata comprises retrieving an API schema and change logs associated with the third-party API.

In some implementations, analyzing the application source code comprises identifying the API usage information associated with the application source code, wherein the API usage information includes one or more API calls, one or more parameters, or a response structure.

In some implementations, the method comprises calculating the risk score based on one or more attributes of the application source code and respective weights associated with the one or more attributes.

In some implementations, the one or more attributes include breaking changes in the application source code, a number of new or changed parameters in the application source code, an API usage frequency in the application source code, a dependency risk associated with the third-party API, or a criticality of the third-party API in the application source code.

In some implementations, the one or more attributes include a changed response structure, and wherein the changed response structure is detected based on the API metadata and an analysis of the application source code.

In some implementations, the method comprises determining that the risk score satisfies a defined threshold, wherein the recommendation is generated based on the risk score satisfying the defined threshold.

In some implementations, generating the recommendation comprises generating a code snippet with modified application source code, wherein the code snippet accommodates changes made by an API provider; and inserting the code snippet into the application source code.

In some implementations, the risk score is calculated and the recommendation is generated as part of a software development flow.

In some implementations, the method comprises: outputting a report that indicates the risk score prior to merging a pull request to the third-party API into a main branch of the application source code.

In some implementations, a computer system comprises: a processor set; one or more computer-readable storage media; and program instructions stored on the one or more computer-readable storage media to cause the processor set to perform operations comprising: obtaining API metadata associated with a third-party API; analyzing application source code to obtain API usage information associated with the application source code; determining a risk score for the application source code, wherein the risk score is based on the API metadata and the API usage information; and generating, based on the risk score, a code snippet with modified application source code to mitigate a risk associated with the third-party API.

In some implementations, obtaining the API metadata comprises retrieving an API schema and change logs associated with the third-party API; and analyzing the application source code comprises identifying the API usage information associated with the application source code, wherein the API usage information includes one or more API calls, one or more parameters, or a response structure.

In some implementations, calculating the risk score is based on one or more attributes of the application source code and respective weights associated with the one or more attributes.

In some implementations, the one or more attributes include breaking changes in the application source code, a number of new or changed parameters in the application source code, an API usage frequency in the application source code, a dependency risk associated with the third-party API, or a criticality of the third-party API in the application source code.

In some implementations, the one or more attributes include a changed response structure, and wherein the changed response structure is detected based on the API metadata and an analysis of the application source code.

In some implementations, the operations further comprise outputting a report that indicates the risk score prior to merging a pull request to the third-party API into a main branch of the application source code.

In some implementations, a computer program product comprises: one or more computer-readable storage media; and program instructions stored on the one or more computer-readable storage media to perform operations comprising: obtaining API metadata associated with a third-party API; analyzing application source code to obtain API usage information associated with the application source code; determining a risk score for the application source code, wherein the risk score is based on the API metadata and the API usage information; generating, based on the risk score, a code snippet with modified application source code; and inserting the code snippet into the application source code.

In some implementations, calculating the risk score is based on one or more attributes of the application source code and respective weights associated with the one or more attributes.

In some implementations, the one or more attributes include breaking changes in the application source code, a number of new or changed parameters in the application source code, an API usage frequency in the application source code, a dependency risk associated with the third-party API, or a criticality of the third-party API in the application source code.

In some implementations, the operations further comprise: outputting a report that indicates the risk score prior to merging a pull request to the third-party API into a main branch of the application source code.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
obtaining, by a server, application programming interface (API) metadata associated with a third-party API;
analyzing, by the server, application source code to obtain API usage information associated with the application source code;
calculating, by the server, a risk score for the application source code, wherein the risk score is based on the API metadata and the API usage information; and
generating, by the server and based on the risk score, a recommendation to mitigate a risk associated with the third-party API.

2. The method of claim 1, wherein obtaining the API metadata comprises:
retrieving an API schema and change logs associated with the third-party API.

3. The method of claim 1, wherein analyzing the application source code comprises:
identifying the API usage information associated with the application source code, wherein the API usage information includes one or more API calls, one or more parameters, or a response structure.

4. The method of claim 1, wherein calculating the risk score is based on one or more attributes of the application source code and respective weights associated with the one or more attributes.

5. The method of claim 4, wherein the one or more attributes include breaking changes in the application source code, a number of new or changed parameters in the application source code, an API usage frequency in the application source code, a dependency risk associated with the third-party API, or a criticality of the third-party API in the application source code.

6. The method of claim 4, wherein the one or more attributes include a changed response structure, and wherein the changed response structure is detected based on the API metadata and an analysis of the application source code.

7. The method of claim 1, further comprising:
determining that the risk score satisfies a defined threshold, wherein the recommendation is generated based on the risk score satisfying the defined threshold.

8. The method of claim 1, wherein generating the recommendation comprises:
generating a code snippet with modified application source code, wherein the code snippet accommodates changes made by an API provider; and
inserting the code snippet into the application source code.

9. The method of claim 1, wherein the risk score is calculated and the recommendation is generated as part of a software development flow.

10. The method of claim 1, further comprising: outputting a report that indicates the risk score prior to merging a pull request to the third-party API into a main branch of the application source code.

11. A computer system comprising:
a processor set;
one or more computer-readable storage media; and
program instructions stored on the one or more computer-readable storage media to cause the processor set to perform operations comprising:
obtaining application programming interface (API) metadata associated with a third-party API;
analyzing application source code to obtain API usage information associated with the application source code;
determining a risk score for the application source code, wherein the risk score is based on the API metadata and the API usage information; and
generating, based on the risk score, a code snippet with modified application source code to mitigate a risk associated with the third-party API.

12. The computer system of claim 11, wherein:
obtaining the API metadata comprises retrieving an API schema and change logs associated with the third-party API; and
analyzing the application source code comprises identifying the API usage information associated with the application source code, wherein the API usage information includes one or more API calls, one or more parameters, or a response structure.

13. The computer system of claim 11, wherein calculating the risk score is based on one or more attributes of the application source code and respective weights associated with the one or more attributes.

14. The computer system of claim 13, wherein the one or more attributes include breaking changes in the application source code, a number of new or changed parameters in the application source code, an API usage frequency in the application source code, a dependency risk associated with the third-party API, or a criticality of the third-party API in the application source code.

15. The computer system of claim 13, wherein the one or more attributes include a changed response structure, and wherein the changed response structure is detected based on the API metadata and an analysis of the application source code.

16. The computer system of claim 13, wherein the operations further comprise:
outputting a report that indicates the risk score prior to merging a pull request to the third-party API into a main branch of the application source code.

17. A computer program product comprising:
one or more computer-readable storage media; and
program instructions stored on the one or more computer-readable storage media to perform operations comprising:
obtaining application programming interface (API) metadata associated with a third-party API;
analyzing application source code to obtain API usage information associated with the application source code;
determining a risk score for the application source code, wherein the risk score is based on the API metadata and the API usage information;
generating, based on the risk score, a code snippet with modified application source code; and
inserting the code snippet into the application source code.

18. The computer program product of claim 17, wherein calculating the risk score is based on one or more attributes of the application source code and respective weights associated with the one or more attributes.

19. The computer program product of claim 18, wherein the one or more attributes include breaking changes in the application source code, a number of new or changed parameters in the application source code, an API usage frequency in the application source code, a dependency risk associated with the third-party API, or a criticality of the third-party API in the application source code.

20. The computer program product of claim 17, wherein the operations further comprise:
outputting a report that indicates the risk score prior to merging a pull request to the third-party API into a main branch of the application source code.
